(19) United States
(12) Patent Application Publication
(10) Pub. No.: US 2013/0290636 A1
(43) Pub. Date: Oct. 31, 2013

(54) MANAGING MEMORY

(71) Applicants: Qiming Chen, Cupertino, CA (US); Ren Wu, San Jose, CA (US); Meichun Hsu, Los Altos Hills, CA (US)

(72) Inventors: Qiming Chen, Cupertino, CA (US); Ren Wu, San Jose, CA (US); Meichun Hsu, Los Altos Hills, CA (US)

(21) Appl. No.: 13/459,362

(22) Filed: Apr. 30, 2012

(51) Int. Cl. G06F 12/08

(52) U.S. Cl. 711/122; 711/135; 711/E12.024; 711/E12.022

(57) ABSTRACT

Methods, and apparatus to cause performance of such methods, for managing memory. The methods include requesting a particular unit of data from a first level of memory. If the particular unit of data is not available from the first level of memory, the methods further include determining whether a free unit of data exists in the first level of memory, evicting a unit of data from the first level of memory if a free unit of data does not exist in the first level of memory, and requesting the particular unit of data from a second level of memory. If the particular unit of data is not available from the second level of memory, the methods further include reading the particular unit of data from a third level of memory. The methods still further include writing the particular unit of data to the first level of memory.

### BACKGROUND

Real-time enterprise applications and data-intensive analytics often require very low latency access to large volumes of data. This data may be distributed across a number of networked devices, e.g., servers. As such, management of memory in which such data is stored can become important.

### BRIEF DESCRIPTION OF THE DRAWINGS

FIG. 1 is representation of a database management system with shared buffer cache for use in describing various implementations.

FIG. 2 is a representation of a Distributed Caching Platform (DCP) for use in describing various implementations.

FIG. 3 is representation of a database system with shared buffer cache extended to DCP in accordance with an implementation.

FIG. 4 is a flowchart of a method of managing memory in accordance with an implementation.

FIG. 5A is a flowchart of a method of managing memory in accordance with an implementation using an overflow model.

FIG. 5B is a flowchart of a method of managing memory in accordance with an implementation using an inclusion model.

FIGS. 6A and 6B illustrate state transitions of implementations using an overflow model and inclusion model, respectively.

FIG. 7 is a graph of a comparison of query response time for sequential data retrieval between a database system of the type shown in FIG. 1 and a database system extended with DCP in accordance with an implementation.

FIG. 8 is a graph of a comparison of query response time for indexed data retrieval between a database system of the type shown in FIG. 1 and a database system extended with DCP in accordance with an implementation.

FIG. 9 is a graph of a comparison of query response time for sequential data retrieval with update between a database system of the type shown in FIG. 1 and a database system extended with DCP in accordance with an implementation.

FIG. 10A is a graph of query performance of a database system extended with DCP in accordance with an implementation comparing the inclusion model to the overflow model for a first query run.

FIG. 10B is a graph of query performance of a database system extended with DCP in accordance with an implementation comparing the inclusion model to the overflow model for a second query run.

### DETAILED DESCRIPTION

In-memory data cache is a promising approach to enable real-time analytics. Various implementations address the issue of scaling out memory cache over multiple devices while providing a common data query language with rich expressive power, and allowing the data cached in memory to persist with atomicity, consistency, isolation, and durability (ACID) properties. Many data analysis applications are designed to store and exchange intermediate or final results through database access, which very often becomes their performance bottleneck.

A memory resource on a single server is typically limited, and may be used by several system components, such as a file buffer, a database buffer, applications, etc. A database buffer pool may be scaled out while providing a unified cache view over multiple server nodes, which may be referred to as memory nodes. As used herein, memory will refer to non-transitory computer-usable storage media in the form of volatile or non-volatile storage. Examples of storage media include solid-state memory (e.g., Read-Only Memory (ROM), Random-Access Memory (RAM), Flash memory, etc.); optical media (e.g., CD, DVD, Blu-Ray™ disks, etc.); magnetic media (e.g., magnetic disks and disk drives, magnetic tape, etc.); and other non-transitory storage media capable of storing data for subsequent retrieval. Such storage media includes storage media as a component part of a computer system, storage media that is removable from a computer system, and storage media that is accessible to the computer system through a network, such as LAN (local area network), WAN (wide area network), Internet, etc., whether network access is available through wired connections or wireless connections.

An example Distributed Caching Platform (DCP) is Memcached. Memcached is an open source, distributed memory object caching system. Memcached allows the creation of virtual memory pools from individual memory stores across multiple networked memory nodes.

Various implementations provide a unified cache view that facilitates access of memory nodes across multiple devices by a database engine. A processor of a computer system may be configured to perform the functions of a database engine in response to machine-readable instructions (e.g., software). With such architectures, the eviction strategy of the database buffer pool and the DCP buffer pool, as well as the data transfer between the two, is addressed. Managing the consistency of the contents between such buffer pools is also addressed, as such buffer pools may reside on individual servers (e.g., computer systems) and may use their own page replacement algorithms, e.g., LRU (Least Recently Used), MRU (Most Recently Used), Clock-Sweep, Usage-Count, etc. Facilitating a reduction in the data transfer between database and DCP buffer pools, and facilitating consistent data access in the presence of multiple distributed data stores, while addressing eviction strategy and managing consistency, may facilitate improvements in system performance and reliability.

Various implementations will be described with reference to the PostgreSQL database engine. In the PostgreSQL database, each table may be physically stored in a file system under a subdirectory. In that subdirectory, there may be a number of files. A single file holds a certain amount of data, e.g., up to 1 GB of data. The file may be treated as a series of pages (often referred to as blocks), with each page holding a particular amount of data, e.g., 8 KB of data.

A database buffer pool is a memory-based data structure, e.g., an array of pages, with each page entry pointing to a memory (e.g., a binary memory) of certain size. Pages in the various examples herein will be presumed to have a page size of 8 KB. It will be apparent that a page size can have other values. Although it is common to utilize page sizes that have 2^{N} bytes, e.g., 8 KB, 16 KB, 32 KB, etc., a page can represent any consistent unit of data. A page in the buffer pool is used to buffer a page of data in the corresponding file, and may be identified by the table space ID, table ID, file ID and the sequence number of the page in the file.

The buffer pool may be accompanied by a buffer pool descriptor that may also be an array of data structures called buffer descriptors. Each buffer descriptor records the information about one page, such as its tag (the above table space ID, table ID, file ID and the sequence number), a usage frequency, a last access time, whether the data is dirty, etc. Maintaining the buffer pool allows the pages to be efficiently accessed in memory without being retrieved from disks.

When a query process wants a page corresponding to a specific file/page it needs, if the page is already cached in the database buffer pool, the corresponding buffered page gets pinned, i.e., forced to remain in the database buffer pool at a fixed location until released. Otherwise, a new page in the database buffer pool may be found to hold this data. If there are no pages free, the process may select a page to evict to make space for the new one. If the selected old page is dirty, i.e., if it has been updated since being loaded to the database buffer pool, it may be written out to disk asynchronously. Then the page on disk may be read into the page in memory and pinned.

Pages may all start out pinned until the process that requested the data releases (e.g., unpins) them. The pinning process, whether the page was found initially or it was read from disk, also increases the usage count of the page. Deciding which page should be removed from the buffer pool to allocate a new one is a classic computer science problem. The usual strategy is based on Least Recently Used (LRU): evict the page that has gone the longest since it was last used. The timestamp when each page was last used may be kept in the corresponding buffer descriptor in order for the system to determine the LRU page; another way may keep pages sorted in order of recent access. There exist other page eviction strategies such as MRU, Clock-Sweep, Usage-Count, etc. For simplicity, various examples generally refer to the page to be evicted as the LRU page, although other eviction policies may be used.

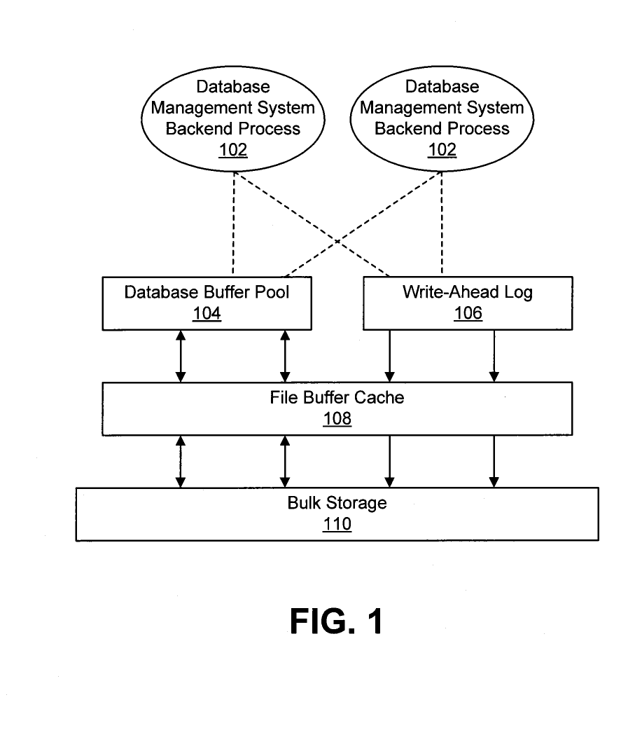

FIG. 1 is representation of a database management system with shared buffer cache for use in describing various implementations. With limited memory space in the database buffer pool 104, much of the data is typically handled through file access from bulk storage 110. However, as shown in FIG. 1, the system also supports in-memory buffering, and the file buffer cache 108 (e.g., a kernel disk buffer cache) and the database buffer pool 104 may compete for memory resources. In general, every page contained in the database buffer pool 104 may also be contained in the file buffer cache 108. Therefore, as a database configuration principle, a database buffer pool 104 is often allocated with moderate memory space. A database buffer pool 104 is an array of data pages, and for a PostgreSQL database engine, the page size is 8 KB. Each page can be treated as a binary object.

The write-ahead log 106 may facilitate maintaining ACID properties of memory transactions. Modifications may be written to the write-ahead log 106 before they are applied, and both redo and undo information is typically stored in the log. The database buffer pool 104, write-ahead log 106, file buffer cache 108 and bulk storage 110 may be shared across multiple database management backend processes 102. Database management backend processes 102 generate calls, such as standard query language (SQL) calls, for data access. As one example, a database management backend process 102 may be a backend process of a PostgreSQL database engine.

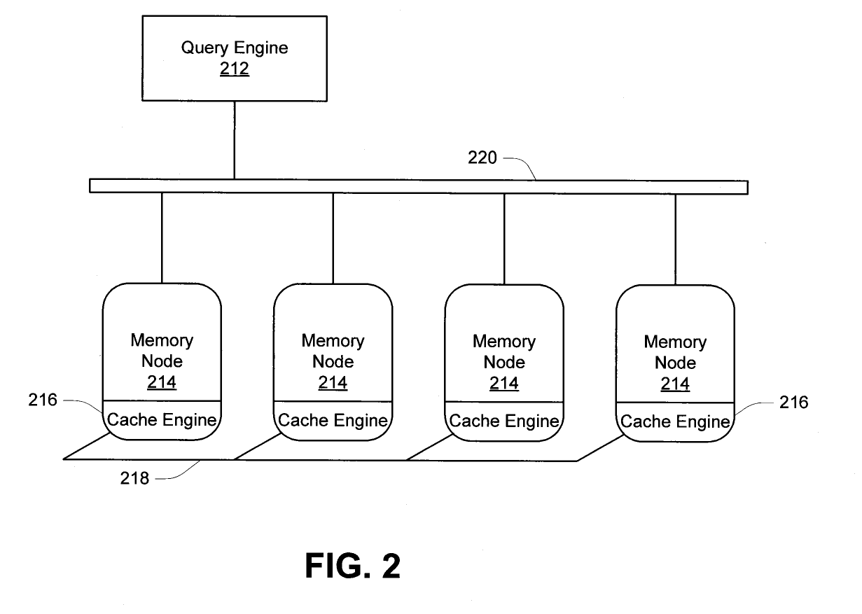

FIG. 2 is a representation of a Distributed Caching. Platform (DCP) for use in describing various implementations. A DCP provides a unified cache view over multiple memory nodes 214, which allows multiple processes to access and update shared data. The memory nodes 214 may represent memory of networked servers. The memory nodes 214 each include a cache engine 216 configured to control access to data stored in the memory nodes 214. A memory node 214 may be in communication with other memory nodes 214 through an interconnection 218. The memory nodes 214 may further be in communication with a query engine 212 through, for example, a unified cache DCP Application Programming Interface (API) 220.

As illustrated in FIG. 2, a DCP can virtualize the memories on multiple memory nodes 214 as an integrated memory. The DCP typically provides APIs for key-value based data caching and accessing, such as get( ) put( ) delete( ) etc., where keys and values are objects. For various implementations, the DCP is a Memcached DCP.

Memcached is a general-purpose distributed caching platform that provides a hash table distributed across multiple networked devices, or memory nodes. The data are hash partitioned to these memory nodes. When the hash table on a memory node is full, subsequent inserts cause older data to be purged, e.g., in a Least Recently Used (LRU) order.

Memcached uses the client-server architecture. The servers maintain a key-value associative array, while the clients populate this array and query it. Under current standards, keys are up to 250 bytes long and values can be at most 1 megabyte in size. Memcached clients use client-side libraries to contact the servers which, by default, expose their service at a specific port. Each client knows all servers, but the servers do not communicate with each other in Memcached. If a client wishes to set or read the value corresponding to a certain key, the client's library first computes a hash of the key to determine the server that will be used, then it contacts that server. The server will compute a second hash of the key to determine where to store or read the corresponding value.

Memcached supports a unified key-value store across multiple memory nodes. On each memory node, an individual Memcached server (e.g., cache engine 216) is launched for managing the local portion of the key-value store.

In integrating a PostgreSQL query engine with an Memcached-based DCP infrastructure, the query engine can act as the DCP client that connects to the Memcached server pool including multiple distributed Memcached servers. These servers cooperate in managing a unified in-memory hash table across multiple nodes. Various implementations extending the buffer pool with Memcached are based on storing buffered pages in such a unified hash table as key-value pairs, where the pages are hash partitioned to separate portions of the unified hash table residing on separate nodes.

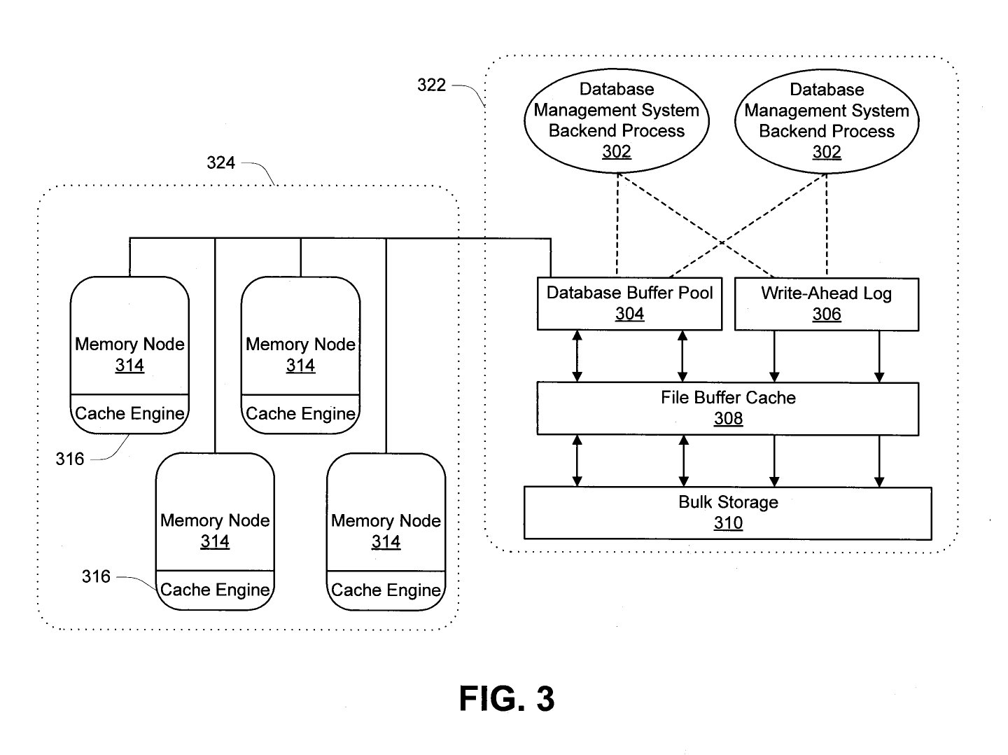

FIG. 3 is representation of a database system with shared buffer cache extended to DCP in accordance an implementation. The extended database system of FIG. 3 includes a database management system 322 and a DCP 324 in communication with the database management system 322. The database management system 322 shown in FIG. 3 includes database management system backend processes 302, database buffer pool 304, write-ahead log 306, file buffer cache 308, and bulk storage 310, which generally cooperate in accordance with the description of database management system backend processes 102, database buffer pool 104, write-ahead log 106, file buffer cache 108, and bulk storage 110 of FIG. 1. The DCP 324 includes memory nodes 314 and cache engines 316, which generally cooperate in accordance with the description of the memory nodes 214 and cache engines 216 of FIG. 2.

The database buffer pool 304 acts as a first level of memory, and various embodiments incorporate the DCP 324 as a second level of memory, and the bulk storage 310 as a third level of memory. As one example, the first level of memory might be volatile solid-state memory local to the computer system 322, the second level of memory might be a collection of volatile solid-state memory across a number of other devices in communication with the computer system 322 (e.g., through a network connection, such as LAN, WAN, Internet, etc.), and the third level of memory might be a disk drive or an array of disk drives either local to or in communication with the computer system 322. Other configurations are permitted as various embodiments are directed to the cooperation among these levels of storage, and are not limited by the location or type of memory being used. For certain embodiments, the amount of storage available in the second level of memory is larger than the amount of storage available in the first level of memory. For certain further embodiments, the amount of storage available in the third level of memory is also larger than the amount of storage available in the second level of memory.

The mapping of a buffered unit of data, e.g., a buffered page, may be handled in the following way. A key is an identifier of the page, and may be composed of a table space ID, a table ID, a file ID, and a series number of the page in the file, and may be serialized to a string key. A value is the content of the page. For example, the 8 KB of binary content of the page of a PostgreSQL database may be treated as the value corresponding to the page key. Note that Memcached's Binary Protocol may be adopted such that a value is passed to the API functions of data transfer by the entry pointer plus the length of bytes of the value.

Various implementations treat the DCP 324 as additional buffer space for the database buffer pool 304, with all the concurrency control, page eviction management and file I/O still handled under the database buffer pool manager. A buffer pool manager (not shown) is a function of a database management system that generally determines if data is buffered, reads the data from bulk storage if it is not buffered, and synchronizes and releases buffered data based on usage. Pages to be cached in DCP 324 go through the database buffer pool 304 under the control of the buffer pool manager. Pages retrieved from DCP 324 also go through the database buffer pool 304 under the control of the buffer pool manager. For various implementations, file I/O and database buffer management functionalities such as page locking are not provided for DCP 324, facilitating data consistency.

For various implementations, if dirty pages in the database buffer pool 304 are to be evicted, any corresponding page in DCP 324 is updated to reflect the current values. In such implementations, if a page does not exist in the database buffer pool 304 but exists in DCP 324, then its content will be up to date in DCP 324. In this manner, DCP 324 may avoid having “out of date” data when accessed. Note also that the database buffer pool 304 may be shared by more than one running query, allowing a dirty page caused by updates from any query to be centrally handled by the buffer pool manager.

For certain implementations, the memory nodes 314 of DCP 324 are private to a single query engine. Such exclusivity could preclude other programs from altering the content of the buffered pages.

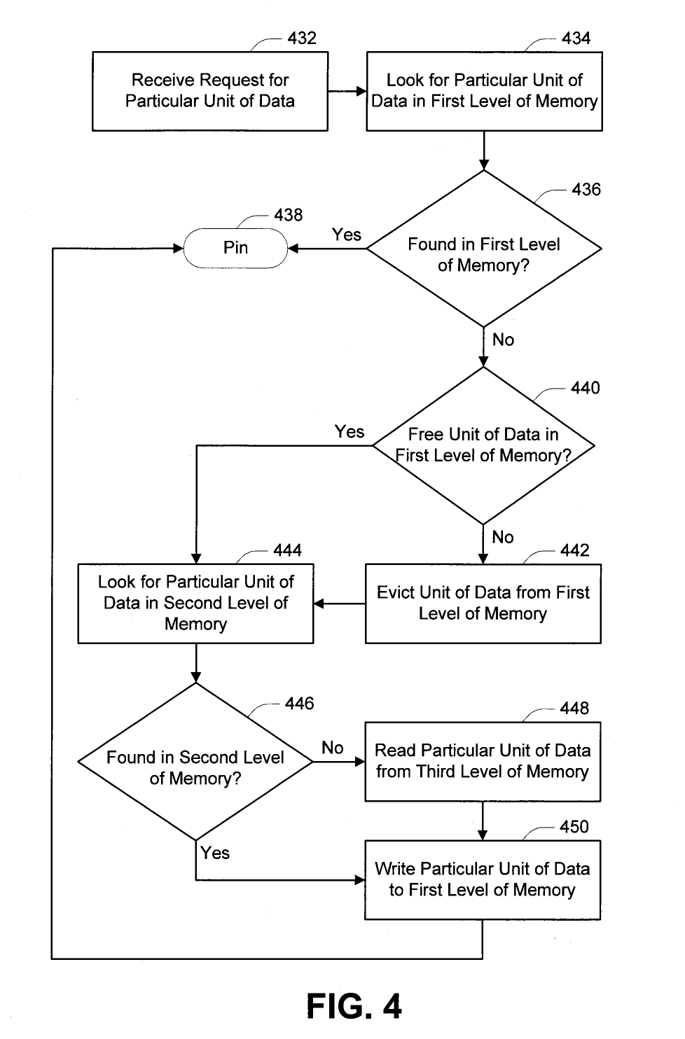

FIG. 4 is a flowchart of a method of managing memory in accordance with an implementation. The method of FIG. 4 will be described with reference to the structure of FIG. 3.

At 432, a request for a particular unit of data is received. For example, a request for a particular page of data may be received from a database management system backend process 302. At 434, a first level of memory (e.g., database buffer pool 304) is searched for the particular unit of data. At 436, it is determined if the particular unit of data was contained in the first level of memory. If it was, the unit of data is pinned at 438. If the particular unit of data was not contained in the first level of memory, at 440, a determination is made as to whether a free unit of data, e.g., a free page, is available in the first level of memory. If no free unit of data is available, a unit of data is evicted from the first level of memory at 442. In either case, a second level of memory (e.g., DCP 324) is searched for the particular unit of data at 444. The second level of memory is in communication with the first level of memory through a network. As such, the second level of memory is responsive to a different processor than the first level of memory. At 446, it is determined if the particular unit of data was contained in the second level of memory. If it was, the particular unit of data may be returned, and the particular unit of data is written to the first level of memory at 450 and pinned in the first level of memory at 438. If the particular unit of data was not contained in the second level of memory, the particular unit of data is read from a third level of memory (e.g., bulk storage 310) at 448, written to the first level of memory at 450, and pinned in the first level of memory at 438.

The generalized method of FIG. 4 may be further enhanced based on either overflow or inclusion models of page buffering as described herein. Under the overflow model of page buffering, given the buffer pool B and the DCP buffering space D (physically located in distributed memory nodes), the unified page buffer (e.g., database buffer pool 304 and DCP 324) is B∪D, and B∩D is a null set. A page evicted from B is moved to D. For certain embodiments, a page p can be moved between B and D, but can only be pinned when p∈B.

For implementations using an overflow model, when a process requests a page (e.g., an 8 KB block), it first tries to get the page from the local database buffer pool. If the page is not found, then it tries to get the page from DCP. If the page is not in DCP, then the page is loaded from bulk storage. In case the database buffer pool is full, it chooses a page to be evicted based on its replacement policy (e.g., LRU, MRU, etc.). The chosen page is evicted and moved to DCP. Each DCP memory node may also enforce its own replacement policy.

More specifically, when a process wants a page, the following buffer allocation algorithm may be used. If the page is already in the database buffer pool, it gets pinned and then returned. Pinning a page prevents the page from being selected for eviction before it is safe to do so, since the database buffer pool may be shared by multiple backend processes. Otherwise, a new buffer block must be found to hold this page. If there is a free block, then it is selected and pinned; else the LRU page is selected to be evicted to make space for the new one; the evicted LRU page is transmitted to DCP to be cached; further, if the LRU page is dirty, it is written out to bulk storage. With a slot in the buffer pool available, the system first tries to load the page content from DCP if the page is found in DCP; otherwise the new data is loaded from bulk storage. In either case, the page is written to the database buffer pool and pinned.

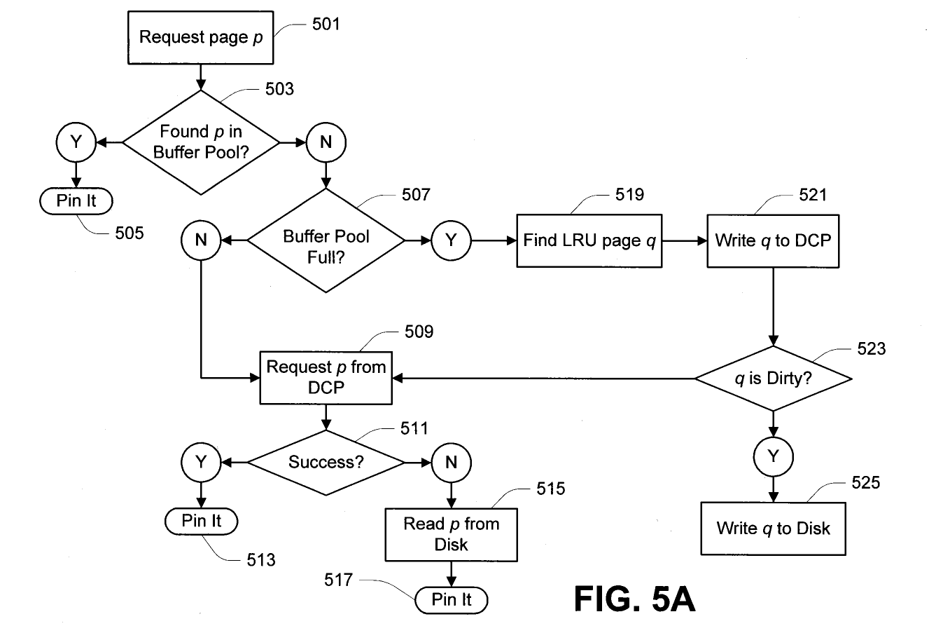

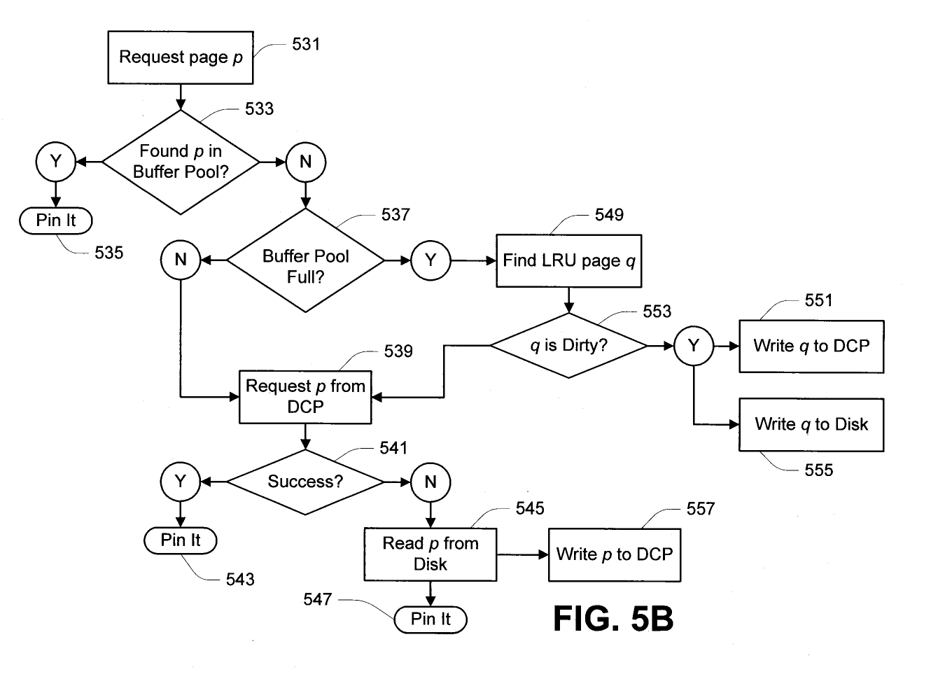

FIG. 5A is a flowchart of a method of managing memory in accordance with an implementation using an overflow model. At 501, a page p is requested. If page p is found in the database buffer pool at 503, it is pinned in the database buffer pool at 505. If page p is not found in the database buffer pool at 503, the database buffer pool is checked to see if it is full at 507.

If the database buffer pool is not full at 507, the page p is requested from DCP at 509. If the page p is returned from DCP at 511, the page p is pinned in the database buffer pool at 513. It is noted that pinning a page from DCP to the database buffer pool includes writing the page to the database buffer pool. If the page p is not returned from DCP at 511, the page p is read from disk at 515, and the page p is pinned at 517. It is noted that pinning a page from disk to the database buffer pool includes writing the page to the database buffer pool.

If the database buffer pool is full at 507, a page q is designated for eviction at 519, such as finding an LRU page. The page q is then written to DCP at 521. If page q is dirty at 523, it is then also written to disk at 525. Whether or not page q is dirty, the method would proceed to 509 and be processed as described in the foregoing paragraph.

In the method of FIG. 5A, all evicted pages, dirty or not, are written to DCP space, possibly overwriting the existing pages in DCP with the same page keys. Conceptually the DCP space provides an overflow buffer for the pages cached in the database buffer pool. System control and data control functions are performed by the database buffer manager with the ACID properties retained.

Under an inclusion model of page buffering, given the buffer pool B and the DCP buffering space D (physically located in distributed memory nodes), the unified page buffer is B∪D, and B⊂D.

For implementations using an inclusion model, when a process requests a page (e.g., an 8 KB block), it first tries to get the page from the local database buffer pool. If the page is not found, then it tries to get the page from DCP. If the page is not in DCP, then the page is loaded from bulk storage and copied to DCP. In case the database buffer pool is full, it chooses a page to be evicted based on its replacement policy (e.g., LRU, MRU, etc.). The chosen page is evicted and, if the page is dirty, it is also transmitted to DCP to refresh DCP's copy.

More specifically, when a process wants a page, the following buffer allocation algorithm may be used. If the page is already in the database buffer pool, it gets pinned and then returned. Otherwise, a new buffer block must be found to hold this page. If there is a free block, then it is selected and pinned; else the LRU page is selected to be evicted to make space for the new one. If the evicted LRU page is dirty, it is transmitted to DCP to be cached and is also written out to bulk storage. Writing to DCP and bulk storage may be done asynchronously. With a slot in the buffer pool available, the system first tries to load the page content from DCP if the page is found in DCP; otherwise the new data is loaded from bulk storage and written to DCP. In either case, the page is written to the database buffer pool and pinned.

FIG. 5B is a flowchart of a method of managing memory in accordance with an implementation using an inclusion model. At 531, a page p is requested. If page p is found in the database buffer pool at 533, it is pinned in the database buffer pool at 535. If page p is not found in the database buffer pool at 533, the database buffer pool is checked to see if it is full at 537.

If the database buffer pool is not full at 537, the page p is requested from DCP at 539. If the page p is returned from DCP at 541, the page p is pinned in the database buffer pool at 543. If the page p is not returned from DCP at 541, the page p is read from disk at 545, and the page p is pinned at 547 and written to DCP at 557.

If the database buffer pool is full at 537, a page q is designated for eviction at 549, such as finding an LRU page. If the page q is dirty at 553, the page q is then written to DCP at 551 and written to disk at 555. Whether or not page q is dirty, the method would proceed to 539 and be processed as described in the foregoing paragraph.

In the method of FIG. 5B, all pages read from disk are copied to the DCP space. However, only the evicted pages which are dirty are written to DCP. Conceptually the pages cached in the buffer pool are included in the DCP space.

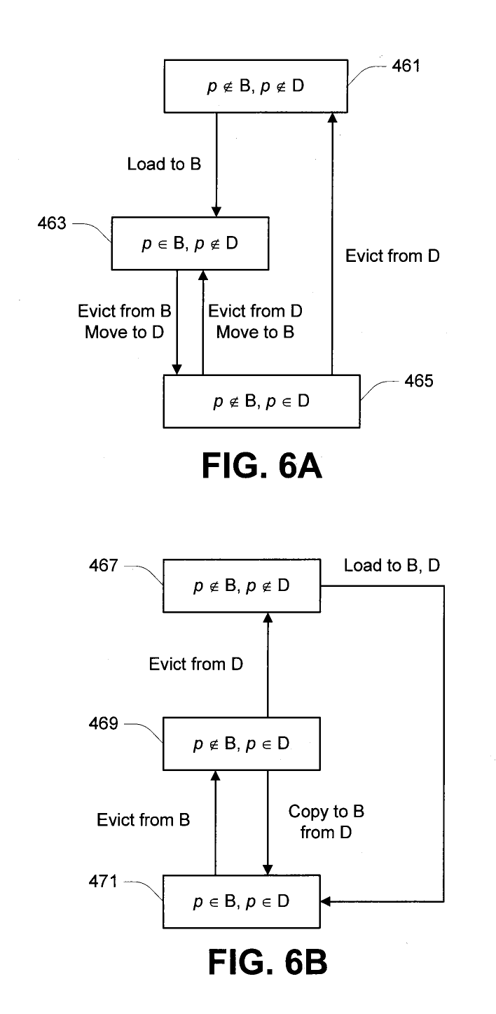

FIGS. 6A and 6B illustrate state transitions of implementations using an overflow model and inclusion model, respectively. Both diagrams start with a state where page p is neither in the database buffer pool (B) nor in the DCP (D), denoted by the state labeled as (p∉B, p∉D).

For the overflow model of FIG. 6A, the initial state is state 461. Upon receipt of a request for page p, p is brought into B and state 461 transitions to state 463, where p∈B and p∉D. From state 463, the possible transition is for p to be evicted from B. In that case, p is moved to D, and the state transitions to state 465, where p∉B and p∈D. From this state 465, there are two possible transitions. The first one is triggered by p being evicted from D, which leads to the initial state 461 of p∉B and p∉D. The second possibility is the arrival of a request for p, which leads to moving p to B from D, and returns to the state 463 where p∈B and p∉D.

In comparison, the inclusion model does not have a state where p∈B and p∉D, but instead has a state where p∈B and p∈D. In more detail, for the inclusion model of FIG. 6B, the initial state is state 467. Upon receipt of a request for page p, p is brought into B and D, and state 467 transitions to state 471, where p∈B and p∈D. From state 471, the possible transition is for p to be evicted from B. In that case, the state transitions to state 469, where p∉B and p∈D. From this state 469, there are two possible transitions. The first one is triggered by p being evicted from D, which leads to the initial state 467 of p∉B and p∉D. The second possibility is the arrival of a request for p, which leads to copying p to B from D, and returns to the state 471 where p∈B and p∉D.

For various embodiments, the choice of using an overflow model or an inclusion model can be specified in a configuration file, and may be changed to suit differing workload characteristics. For example, when a PostgreSQL query engine starts, the corresponding code sections in the storage module are executed depending upon the active model.

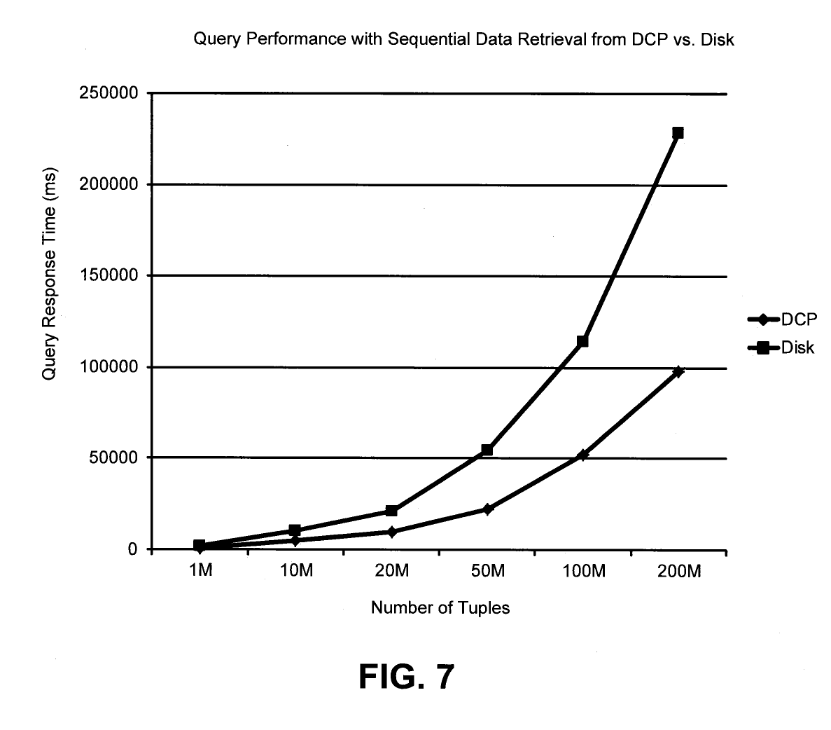

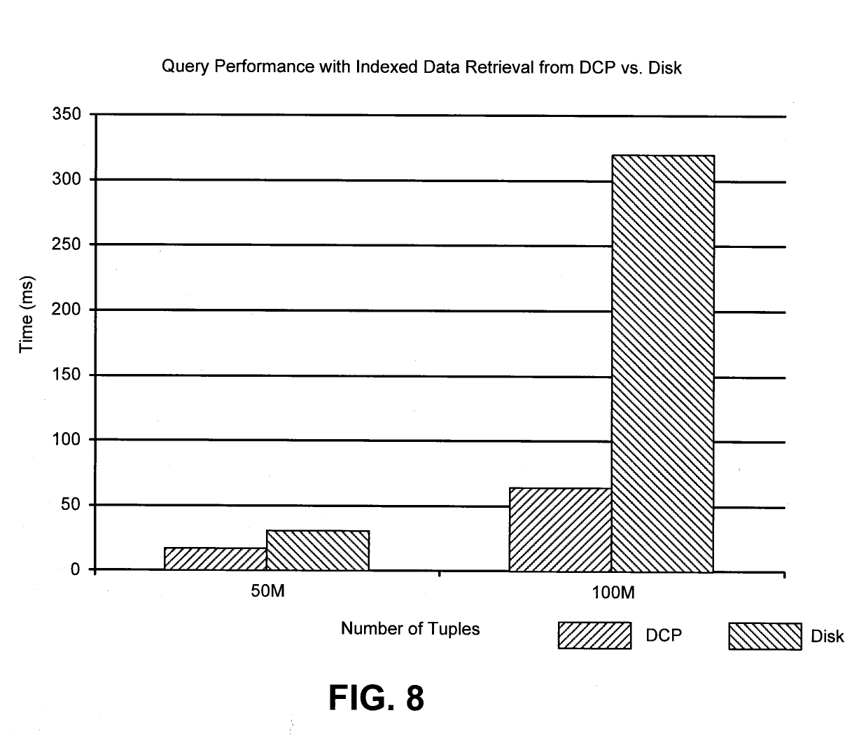

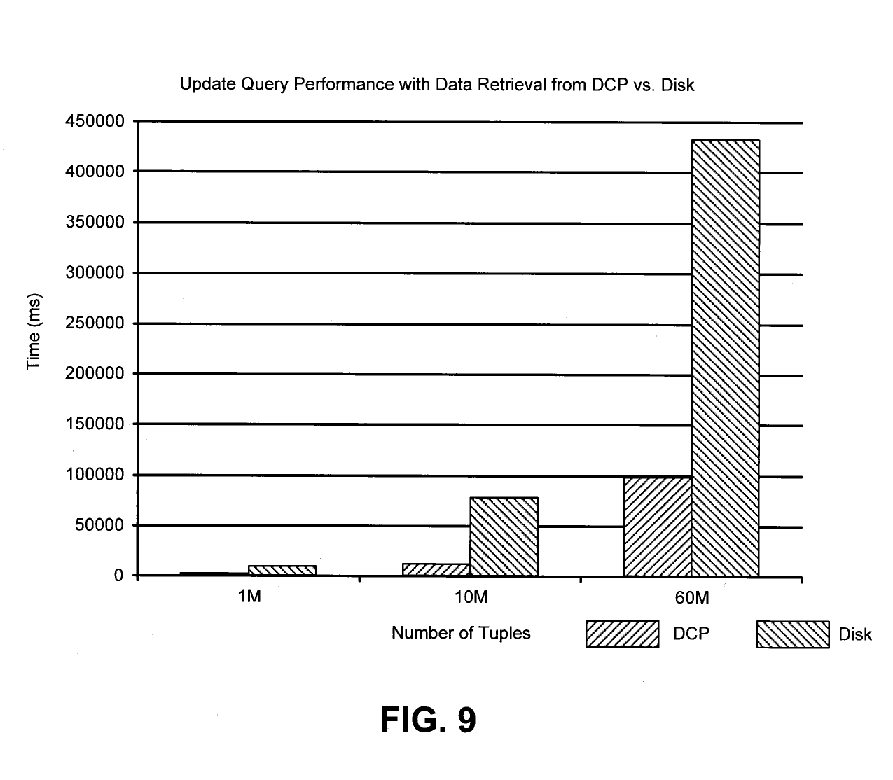

FIGS. 7-9 are graphs of comparisons of query performance between a database system of the type shown in FIG. 1 (labeled “Disk”) and a database system extended with DCP in accordance with an implementation, such as the type shown in FIG. 3 (labeled “DCP” and using the inclusion model). FIG. 7 compares query response time for sequential data retrieval between the two systems as demonstrated using like servers, databases and queries across various database sizes. FIG. 8 compares query response time for indexed data retrieval between the two systems as demonstrated using like servers, databases and queries across various database sizes. FIG. 9 compares query response time for sequential data retrieval with update between the two systems as demonstrated using like servers, databases and queries across various database sizes. Each example demonstrates possible performance gains over a database system of the type shown in FIG. 1.

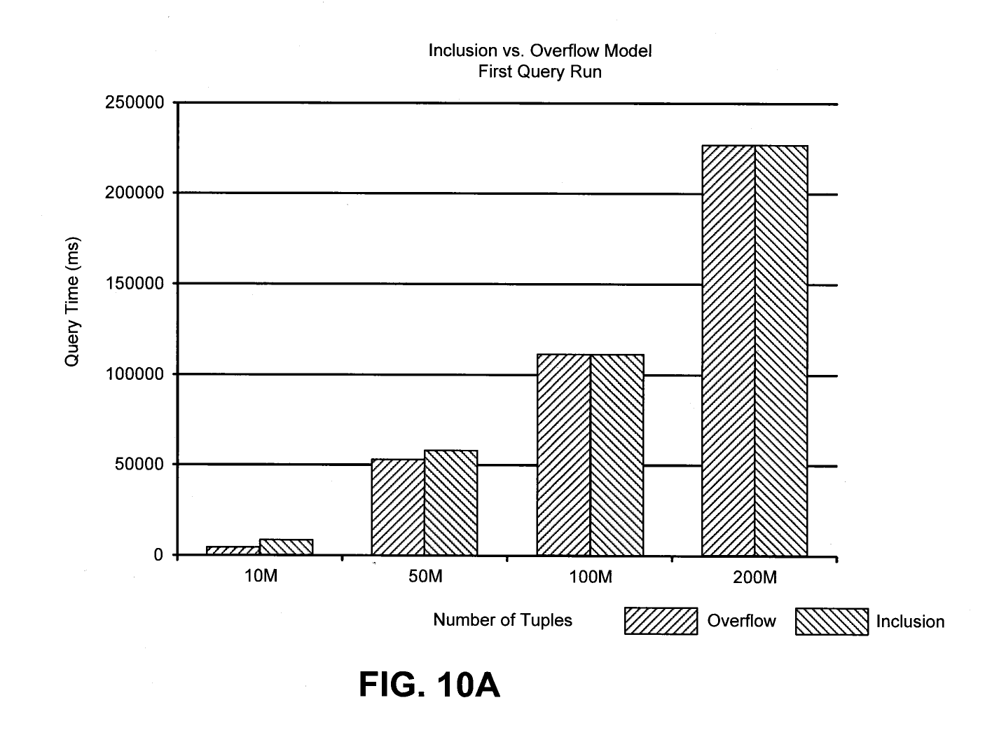

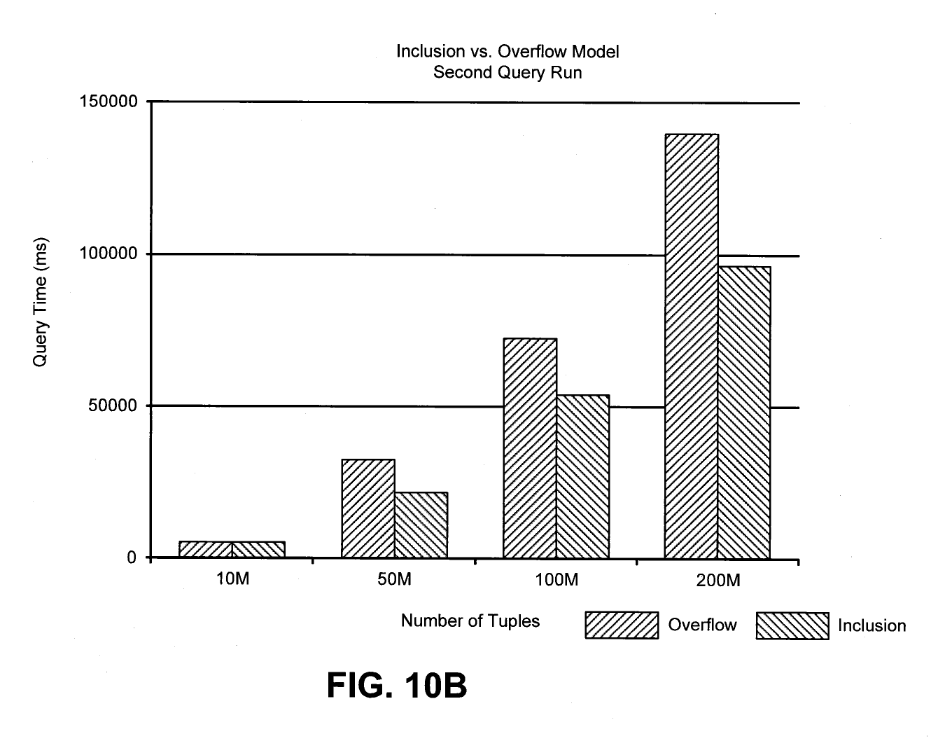

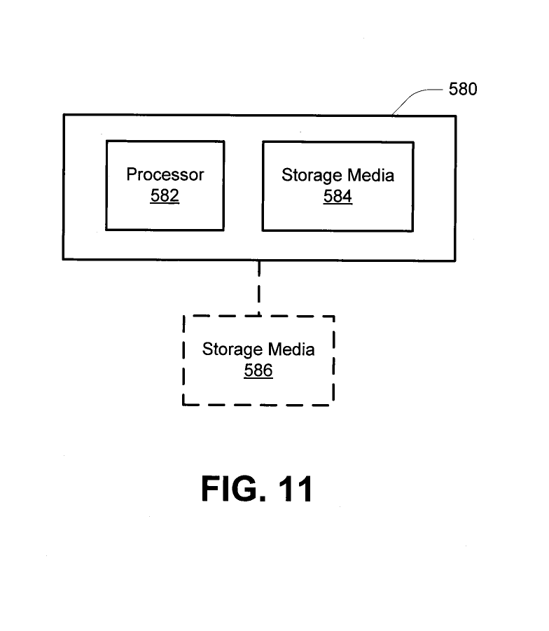

FIGS. 10A-10B are graphs of query performance of a particular database system extended with DCP in accordance with an implementation, such as the type show in FIG. 3, across various database sizes comparing the inclusion model to the overflow model. As shown in FIG. 10A, there is minimal performance difference on a first query run regardless of whether the inclusion model or the overflow model is chosen. However, as shown in FIG. 10B, significant performance gains can be facilitated for larger database sizes for second, and subsequent, query runs under the inclusion model.

For the foregoing examples of query performance, the database sizes were larger than the database buffer pool size, and the total cache size of the DCP was larger than the database size. In the initial data loading phase, under the overflow model, most pages loaded to the database buffer pool will eventually “overflow” (i.e., be evicted and moved) to DCP, therefore the costs of loading pages to DCP under the overflow model and the inclusion model might be expected to be similar. However, after most or all pages are stored to DCP, under the overflow model, every page evicted from the database buffer pool is moved to DCP. In contrast, under the inclusion model, only the dirty pages evicted from the database buffer pool will involve moving the content to DCP, i.e., to refresh the corresponding content in DCP. For non-dirty pages, only a notification to DCP might be performed.

It will be appreciated that implementations of the present disclosure can be instantiated by machine-readable instructions, e.g., software, configured to cause a processor to perform methods disclosed herein. The machine-readable instructions can be stored on non-transitory computer-usable storage media in the form of volatile or non-volatile storage. Examples of such storage media include solid-state memory (e.g., Read-Only Memory (ROM), Random-Access Memory (RAM), Flash memory, etc.); optical media (e.g., CD, DVD, Blu-Ray™ disks, etc.); magnetic media (e.g., magnetic disks and disk drives, magnetic tape, etc.); and other non-transitory storage media capable of storing data for subsequent retrieval. Such storage media includes storage media as a component part of a computer system, storage media that is removable from a computer system, and storage media that is accessible to the computer system through a network, such as LAN (local area network), WAN (wide area network), Internet, etc., whether network access is available through wired connections or wireless connections.

FIG. 11 is a block diagram of an example of a computer system 580 having a processor 582 and a computer-usable non-transitory storage media 584 in communication with the processor 580 for use with various implementations. The storage media 584, whether removable from, a component part of, or accessible to computer system 580, includes a non-transitory storage medium having machine-readable instructions stored thereon configured to cause the processor 582 to perform methods disclosed herein, and may include more than one non-transitory storage medium. For example, the machine-readable instructions could be configured to cause the processor 582 to perform the function of the database management system backend process 302 and the memory management functions of the computer system 322, including communicating requests to the DCP 324. It is noted that while the processor 582 would communicate requests to the DCP 324 in this example, one or more processors separate from processor 582 would be responsible for reading data from, or writing data to, DCP 324. For example, a memory node 314 might be a computer system, like computer system 580, and include a storage media, like storage media 584, and the cache engine 316 might be a function of a processor, like processor 582, in response to machine-readable instructions to read or write data to the memory node 314.

The computer system 580 may further be in communication with a computer-usable non-transitory storage media 586. The storage media 586 includes at least one storage media (e.g., removable or network-accessible storage media) storing the machine-readable instructions configured to cause the processor 582 to perform methods disclosed herein as part of an installation package to store the machine-readable instructions to storage media 584.

What is claimed is:

1. A method of managing memory, comprising:
requesting a particular unit of data from a first level of memory;
if the particular unit of data is not available from the first level of memory, determining whether a free unit of data exists in the first level of memory, evicting a unit of data from the first level of memory if a free unit of data does not exist in the first level of memory, and requesting the particular unit of data from a second level of memory;
if the particular unit of data is not available from the second level of memory, reading the particular unit of data from a third level of memory; and
writing the particular unit of data to the first level of memory;
wherein the second level of memory is responsive to a different processor than the first level of memory.

2. The method of claim 1, further comprising:
writing the evicted unit of data to the second level of memory.

3. The method of claim 2, wherein writing the evicted unit of data to the second level of memory occurs only if the evicted unit of data has been updated from a corresponding unit of data in the third level of memory.

4. The method of claim 3, further comprising:
writing the particular unit of data to the second level of memory after reading the particular unit of data from the third level of memory.

5. The method of claim 1, further comprising:
writing the evicted unit of data to the third level of memory if the evicted unit of data has been updated from a corresponding unit of data in the third level of memory.

6. The method of claim 1, wherein writing the particular unit of data to the first level of memory further comprises pinning the particular unit of data in the first level of memory.

7. The method of claim 1, wherein requesting the particular unit of data from a second level of memory comprises requesting the particular unit of data from a memory node of a distributed cache platform.

8. The method of claim 1, wherein evicting a unit of data from the first level of memory comprises evicting a unit of data from the first level of memory based on an eviction strategy selected from the group consisting of Least Recently Used, Most Recently Used, Clock-Sweep, and Usage-Count.

9. A non-transitory computer-usable storage media having machine-readable instructions stored thereon and configured to cause a processor to perform a method, the method comprising:
requesting a particular unit of data from a first level of memory;
if the particular unit of data is not available from the first level of memory, determining whether a free unit of data exists in the first level of memory, evicting a unit of data from the first level of memory if a free unit of data does not exist in the first level of memory, and requesting the particular unit of data from a second level of memory in communication with the first level of memory through a network;
if the particular unit of data is not available from the second level of memory, reading the particular unit of data from a third level of memory; and
writing the particular unit of data to the first level of memory.

10. The non-transitory computer-usable storage media of claim 9, wherein the non-transitory computer-usable storage media stores the machine-readable instructions as part of an installation package to store the machine-readable instructions to another non-transitory computer-usable storage media in communication with the processor.

11. The method of claim 9, further comprising:
writing the evicted unit of data to the second level of memory.

12. The method of claim 10, wherein writing the evicted unit of data to the second level of memory occurs only if the evicted unit of data has been updated from a corresponding unit of data in the third level of memory.

13. The method of claim 12, further comprising:
writing the particular unit of data to the second level of memory after reading the particular unit of data from the third level of memory.

14. The method of claim 9, further comprising:
writing the evicted unit of data to the third level of memory if the evicted unit of data has been updated from a corresponding unit of data in the third level of memory.

15. The method of claim 9, wherein requesting the particular unit of data from a second level of memory comprises requesting the particular unit of data from a memory node of a distributed cache platform.

16. A database system, comprising:
a distributed cache platform comprising non-transitory storage media;
a bulk storage comprising non-transitory storage media and storing a database;
a computer system comprising a database buffer pool comprising non-transitory storage media, and a processor configured to perform a method of managing memory, comprising:
requesting a particular unit of data of the database from the database buffer pool;
if the particular unit of data is not available from the database buffer pool, determining whether a free unit of data exists in the database buffer pool, evicting a unit of data from the database buffer pool if a free unit of data does not exist in the database buffer pool, and requesting the particular unit of data from the distributed cache platform;
if the particular unit of data is not available from the distributed cache platform, reading the particular unit of data from the bulk storage; and
writing the particular unit of data to the database buffer pool.
